(19) United States
(12) Patent Application Publication
(10) Pub. No.: US 2022/0145006 A1
(43) Pub. Date: May 12, 2022

(54) PROCESS FOR CONDITIONING AND REUSING SALT-CONTAINING PROCESS WATER

(71) Applicant: COVESTRO INTELLECTUAL PROPERTY GMBH & CO. KG, Leverkusen (DE)

(72) Inventors: Yuliya SCHIESSER, Troisdorf (DE); Knud WERNER, Krefeld (DE); Andreas BULAN, Langenfeld (DE)

(21) Appl. No.: 17/438,014

(22) PCT Filed: Mar. 10, 2020
(86) PCT No.: PCT/EP2020/056392

§ 371 Date: Sep. 10, 2021

(30) Foreign Application Priority Data
Mar. 13, 2019 (EP) 19162515.1

(51) Int. Cl. C08G 64/24; C01B 32/80; C08G 64/06; B01J 20/20; C01B 32/318; C25B 1/46; C25B 15/08; B01D 61/02; B01D 69/02; B01D 71/56; B01D 15/08

(52) U.S. Cl. CPC C08G 64/24; B01D 2325/20; C08G 64/06; B01J 20/20; C01B 32/318; C25B 1/46; C25B 15/081; B01D 61/027; B01D 69/02; B01D 71/56; B01D 15/08; B01D 2311/04; B01D 2311/2634; B01D 2311/2684; B01D 2311/2626; C01B 32/80

(57) ABSTRACT

The invention relates to an integrated process for conditioning process water (1) from the production (I) of polycarbonate, which process water contains at least catalyst residues and/or organic impurities and sodium chloride, and subsequently utilizing the process water (1) in a subsequent sodium chloride electrolysis (V).

The invention relates to a process for workup of salt-containing process water for example from production of polycarbonate by the solution polymerization process (SPC) and diphenyl carbonate (DPC) with the objective of utilizing the salt in chloralkali (CA) electrolysis.

The invention proceeds from processes known per se for workup of salt-containing wastewater from polycarbonate production with the objective of achieving the most sparing possible use of the raw material sodium chloride which is required for chlorine production and avoiding the problematic discharge of salt-containing wastewater to the environment, i.e. into watercourses.

The production of polycarbonate via the solution polymerization process (SPC) is typically carried out by a continuous process by production of phosgene and subsequent reaction of bisphenols and phosgene in the presence of alkali metal hydroxide and a nitrogen catalyst, chain terminators and optionally branching agents in a mixture of aqueous alkaline phase and organic solvent phase at the interface.

By contrast, the production of diaryl carbonates (DPC) is typically carried out by a different continuous process, i.e. by production of phosgene and subsequent reaction of monophenols and phosgene in an inert solvent in the presence of alkali metal hydroxides and a basic nitrogen catalyst at the interface between the organic and aqueous phase.

Suitable catalysts for the reaction in principle include any catalysts known for the production of polycarbonates by the interfacial process, such as tertiary amines, N-alkylpiperidines or pyridine. The employed amine catalyst may be open-chain or cyclic, and triethylamine and ethylpiperidine are typical.

Usually employable inert organic solvents include all known solvents and mixtures thereof which are capable of dissolving polycarbonate to an extent of at least 5% by weight at a temperature of around 20° C. Typical solvents are dichloromethane and mixtures of dichloromethane and monochlorobenzene.

Reaction between the solvent and catalysts may inter alia occur during the production process, wherein formation of byproducts results in formation of ammonium salts.

After the reaction, in both processes (LPC and DPC production) the organic, polycarbonate-containing phase is typically separated from the NaCl-containing reaction water, washed with an aqueous liquid (washing water) and separated from the aqueous phase as far as possible after each washing operation. The resulting NaCl-containing reaction water contaminated with secondary organic constituents may be stripped with steam separately or in admixture with washing water and, in principle, reused. The obtained process waters are hereinbelow also referred to as LPC or DPC process water for short. The abovementioned procedure is described for example in EP 2 229 343 A1.

The aqueous phases (LPC or DPC process water) having a sodium chloride content of typically around 5% to 20% by weight (process water) could in principle be reused in chloralkali electrolysis (hereinbelow also CA electrolysis for short) to produce chlorine and sodium hydroxide.

However, the use of these process waters in CA electrolysis requires that certain threshold values of organic and inorganic impurities must be observed to prevent damage to membranes and/or electrodes of the electrolyzers through deposits or chemical processes.

Possible primary impurities in the process water from polycarbonate production typically include phenol, bisphenol A, phenol and benzene derivatives having various alkyl substitutions and also halogenated aromatics (for example butylphenol, isopropylphenol, trichlorophenol, dibromophenol, etc.) and also polar aliphatic amines and salts thereof (trimethylamines, butylamines, dimethylbenzylamines) and ammonium compounds and salts thereof. As a consequence of production, the process waters from diphenyl carbonate (DPC) and polycarbonate production by the interfacial process (LPC production for short) typically have a pH in the range from 12 to 14 and have a typical concentration of sodium chloride in the range from 5% to 7% by weight (in the case of the LPC process) and of 14% to 17% by weight (in the case of the DPC process). The process waters may further contain carbonates in a concentration of up to 10 g/L.

Phenol and its derivatives, bisphenol A and further high molecular weight organic compounds are chlorinated in the chloralkali electrolysis and form AOX (adsorbable organic halogen compounds). Tertiary ammonium compounds and salts thereof and also all amines result in the formation of NC13, a highly explosive hazardous substance, and in an increase in the cell voltage in the chloralkali electrolysis and thus in increased energy consumption. Furthermore, the oxidation products of these organic impurities likewise result in a voltage increase in the CA electrolysis. All of these impurities should be removed from the respective process water to the greatest possible extent in order to allow economic utilization of the process water for the electrolysis.

Inorganic impurities in the process waters (Ca, Mg, Si, Mn, Ni, etc.) result in an increase in the electrical voltage in the CA electrolysis and should likewise be removed to the greatest possible extent.

It is a particular object of the invention to reduce the proportion of the abovementioned impurities, in particular of the ammonium compounds and salts thereof, to a predetermined threshold value to allow the process waters to be safely employed in the chloralkali electrolysis.

Various measures for workup of salt-containing process waters from the production of polycarbonate are known from the prior art and have been described in numerous publications.

WO 2017/001513 A1 and WO2015168339A1 describe a process for purification and concentration of process water in which the process water is to be sent for use in CA electrolysis after appropriate purification, inter alia fine purification over activated carbon, and subsequent concentration by osmotic distillation. However, the inventors have found in their own experiments that the recited impurities are not, or not completely, removed from the process water by the activated carbon. Especially ammonium compounds and salts thereof are characterized by poor adsorbability on the activated carbon.

Patent specification U.S. Pat. No. 6,214,235B1 describes a process for removing ammonium salts from sodium chloride solutions using adsorbents (activated carbon, ion exchangers, carbonized ion exchangers). Premature breakthrough of ammonium salts through the activated carbon bed in the case of an elevated feed loading and thus entry of the contaminated solution into the chloralkali electrolysis likewise cannot be ruled out when using this known purification process.

Patent specification U.S. Pat. No. 6,340,736B1 describes a process for purification and concentration of process water in which the purification is effected by catalytic oxidation and this is followed by evaporative concentration to increase the sodium chloride concentration. However, the oxidation products formed in the oxidation are likewise concentrated in the process water (especially in the anolyte circuit of the CA electrolysis) and consequently result in an undesired voltage increase upon use as brine in the CA electrolysis. A voltage increase in the electrolysis has the result that the overall energy consumption for the electrolysis increases, thus not only making production of chlorine and sodium hydroxide solution less economical but also constituting an undesirable environmental burden due to an increase in primary energy consumption (CO₂ emissions issues).

Laid-open specification DE102007004164A1 describes a process for elimination of nitrogen-containing organic compounds from salt-containing water by oxidation with subsequent adsorption. The described process is only intended and suitable for a water having a concentration of nitrogen-containing organic compounds of more than 50 ppm.

Starting from the recited prior art, the problem addressed by the present invention is that of providing an integrated process for workup of salt-containing process water from polycarbonate production, wherein the salt-containing process water from polycarbonate production is purified such that it may be safely and unproblematically reused in a chloralkali electrolysis for producing chlorine and sodium hydroxide solution without accepting the above-described industrial disadvantages for the electrolysis. The process water shall especially be worked up such that it is virtually free from ammonium compounds and salts thereof before it is used as electrolysis brine.

It has surprisingly been found that an additional membrane-based purification stage (nanofiltration) has the result that the pretreated process water is largely freed of ammonium compounds and salts thereof and may be sent to the CA electrolysis. The process water is additionally freed of polyvalent inorganic ions.

The invention provides an integrated process for workup of process water containing at least catalyst residue and/or organic impurities and sodium chloride from the production of polycarbonate, in particular of diaryl carbonates or of polycarbonate by the solution polymerization process, and subsequent processing of the process water in a downstream sodium chloride electrolysis, comprising at least the steps of:
a) production of phosgene by reaction of chlorine with carbon monoxide,
then either
b1) reaction of the phosgene formed in step a) with at least one bisphenol in the presence of sodium hydroxide solution and optionally catalyst to afford a polycarbonate and a sodium chloride-containing aqueous solution,
or
b2) transesterification of one or more bisphenols with one or more diaryl carbonates to afford the oligo/polycarbonate and the monophenol,
   isolation/separation of the polycarbonate and the monophenol,
   reaction of the monophenol in the presence of sodium hydroxide solution and of catalyst with phosgene and separation of the products aqueous sodium chloride solution, polycarbonate and diaryl carbonate, wherein the diaryl carbonate is preferably reused in the initial transesterification,
c) separation of the aqueous sodium chloride-containing solution (process water) obtained in step b1) or b2) from solvent residues and/or optionally catalyst residues, in particular by stripping the solution with steam, then adjustment of the prepurified solution to a pH of not more than 8 and subsequent purification of the prepurified NaCl solution with adsorbents, in particular with activated carbon,
d) electrochemical oxidation of at least a portion of the sodium chloride-containing solution obtained from step c) to form chlorine, sodium hydroxide solution and optionally hydrogen,
e) wherein at least a portion of the chlorine produced in step d) is recycled into the production of phosgene in step a) and/or
f) optionally at least a portion of the alkali metal hydroxide solution produced in step d) is recycled into the production of polycarbonate in step b1),

characterized in that following the purification of the sodium chloride-containing solution with absorbents in step c) the purified NaCl-containing solution is in an additional step c1) subjected to a nanofiltration, wherein the NaCl-containing solution is resolved into a highly purified NaCl solution as permeate and an NaCl-containing concentrate comprising organic and inorganic impurities, the highly purified NaCl solution is sent to the electrochemical oxidation d) and the concentrate is worked up or discarded as desired.

The objective of the prepurification in step c) and in particular step c1) in the novel process is the recycling of salt-containing process water to ensure safe and unproblematic utilization of the process water in the electrolysis for producing chlorine. As more particularly described hereinabove, the process waters contain organic and inorganic impurities and/or catalyst residues, in particular of nitrogen catalysts/basic nitrogen catalysts, which are to be removed. The recirculation of the brine in the CA electrolysis would otherwise result in accumulation of the impurities and thus in downgrading of the product quality and even damage to the production plants.

Nanofiltration for the removal of organic impurities from the process waters from polycarbonate production would be insufficient as a sole process step and is hindered by concomitant effects, such as membrane fouling and blocking of the membrane. In-house investigations have shown that only 50% to 60% of the total TOC (Total Organic Carbon) was retained by mere use of a nanofiltration membrane (see example 4). It is well known from the literature that organic impurities, inter alia phenol, phenol derivatives and bisphenol A, can result in fouling and blocking of the membranes on account of the adsorptive interactions with the membrane material, thus fundamentally impeding the use of filter membranes (Separation and Purification Technology 63 (2008) 251-263; Water Research Volume 40, Issue 20, December 2006, pages 3793-3799). This is also confirmed by in-house investigations with doped solutions as described in example 2 hereinbelow.

Organic ammonium compounds and ammonium salts thereof, for example N-ethylpiperidine and its reaction product with dichloromethane, are characterized by poor adsorbability on activated carbon. Removing these compounds from the process water with activated carbon as quantitively as possible requires a large amount of activated carbon as adsorber which also requires very frequent replacement. In order to nevertheless safely operate the known purification process with activated carbon, the activated carbon capacity is for safety's sake only utilized to an extent of up to 50-75%. Otherwise, complex control analytics would be necessary to be able to rule out premature breakthrough of the organic impurities, in particular organic ammonium compounds and ammonium salts thereof, through the activated carbons and entry into the chloralkali electrolysis.

The above-described technical problem is solved by the process according to the invention consisting of a prepurification with the objective of removing the easily adsorbable organic impurities from the process waters from polycarbonate production and post-purification by nanofiltration with the objective of removing persistent compounds such as the recited ammonium compounds (catalyst residues) and ammonium salts thereof.

The prepurification is useful for removing for example phenols (for example unsubstituted phenol, alkylphenols) and further adsorbable aromatic compounds (for example bisphenol A) from the process water since these cannot be separated by the nanofiltration and can also result in blocking of the nanofiltration membranes.

The removal of the easily adsorbable impurities may be effected in different ways and at different points in the process. Prepurification of DPC and LPC process water shall preferably be effected by treatment with activated carbon at a pH of not more than 8. Since these have surprisingly proven particularly suitable it is particularly preferable to use activated carbons based on, especially pyrolyzed, coconut shells, in particular those which have additionally been subjected to an acid and subsequently an alkaline washing to remove inorganic constituents from the activated carbon. Coconut shell-based activated carbon is particularly characterized by its fine pores (in the micrometer range) and a high hardness and thus markedly less carbon abrasion. The acid and alkaline washing additionally has the result that washing out of mineral constituents from the activated carbon during the prepurification step c) for process water is minimized Prepurification may alternatively be performed using other adsorbents (zeolites, macroporous and mesoporous synthetic resins, zeolites etc.). The prepurification c) should particularly preferably reduce the total concentration of phenol, phenol derivatives and bisphenol A to a value of not more than 2 mg/L.

In a preferred embodiment of the novel process in the purification c) the sodium chloride-containing solution is before the adsorption adjusted to a pH of not more than 7, in particular through use of hydrochloric acid or hydrogen chloride.

The nanofiltration membranes (NF membranes) used may generally be symmetrical or asymmetrical membranes. It is preferable to use asymmetric composite membranes consisting of a plurality of layers (up to 4) having different parameters (polymer type, layer thickness, porosity, degree of crosslinking of the polymer etc.). The separation-active layer of the NF membrane may likewise be manufactured from different polymers, wherein many commercially available NF membranes have a separation layer based on piperazinamide. A decisive parameter for the separation task is the separation limit of the active layer of the membrane (MWCO Molecular Weight Cut Off). It is preferable to employ an NF membrane having a separation limit (MWCO) of 150 to 300 Da, particularly preferably 180 to 220 Da, in the nanofiltration.

NF membranes of various geometries (flat membranes, hollow fiber, tube membranes) may in principle be used. It is preferable to use flat membranes which are commercially available in the form of spiral wound modules.

Nanofiltration is a pressure-driven membrane process for workup of aqueous solutions containing different salts which is known per se. A special feature of nanofiltration membranes is their ion selectivity: Salts having monovalent anions can largely pass through the membrane (depending on the membrane) while salts having polyvalent anions (for example sulfates and carbonates) are very largely retained. This ion selectivity of nanofiltration is based on negatively charged groups on/in the membrane which through electrostatic interactions prevent permeation of polyvalent anions. Having regard to the separation of organic components from aqueous solutions nanofiltration membranes achieve appreciable retentions only above a molar mass of M=200 kg/kmol (see for example Membrane Processes, R. Rautenbach et al., 1989, John Wiley & Sons Ltd.).

The separation of polyvalent inorganic impurities from sodium chloride solution for use in chloralkali electrolysis is known. This may be effected directly using nanofiltration membranes (WO2014008593) or, as described in EP1858806B1, performed by initial addition of retention-enhancing components and subsequent nanofiltration.

In a preferred embodiment of the novel process the nanofiltration c1) is performed at a temperature of 10° C. to 45° C., preferably of 20° C. to 45° C., particularly preferably of 20° C. to 35° C.

The operating pressure on the feed upstream of the nanofiltration c1) is typically preferably 5 bar to 50 bar, particularly preferably from 15 to 45 bar.

In a preferred embodiment of the invention the nanofiltration c1) can be used to treat prepurified NaCl-containing waters having an NaCl concentration in the range from 4% by weight to 20% by weight, preferably an NaCl concentration of 7% and 20% by weight.

A measure of the separation sharpness of a membrane is the retention capacity or retention Ri in respect of a component i which is defined as follows according to the concentrations in the feed and permeate:

$${R}_{i} = ( 1 - \frac{{y}_{i}}{{x}_{i}} ) \cdot 100 \%$$

Here:

Ri is retention capacity

yᵢ is the amount of substance fraction of the component i in the permeate

xⱼ is the amount of substance fraction of the component i in the feed

In a preferred embodiment of the invention the retention of the nanofiltration membrane the for NaCl is not more than 10%, particularly preferably not more than 5%. A higher retention may require a higher operating pressure and is energetically disadvantageous.

In a further preferred embodiment of the invention the nanofiltration c1) is operated such that in the nanofiltration c1) at least 50% by weight, preferably at least 70% by weight, of the sodium chloride present in the prepurified NaCl solution before the nanofiltration c1) (100% by weight) is retained in the permeate.

In a particular embodiment of the invention the retention of the nanofiltration membrane for ammonium compounds and salts thereof shall in each case independently be more than 90%.

In a further particular embodiment of the invention the permeate flow through the membrane during the nanofiltration shall be from 15 to 40 L/(hm²).

The pH of the process water for the treatment with nanofiltration may typically vary between 2 and 10 and be chosen according to further process steps. In the novel process the pH of the process water in the nanofiltration is particularly preferably adjusted to 3 to 8.

The resulting permeate which is substantially free from ammonium compounds and salts thereof is concentrated through addition of solid salt and supplied to the CA electrolysis brine circuit. The concentration may optionally be effected by means of concentration processes such as evaporative concentration, high-pressure reverse osmosis, membrane distillation, osmotic distillation etc. The resulting NF concentrate may either be discarded or optionally freed from ammonium compounds and salts thereof and further polyvalent ions in concentrated form using adsorptive processes (activated carbon, ion exchangers) and likewise concentrated and supplied to the CA electrolysis brine circuit.

Any proportions of alkali metal carbonate in the sodium chloride solution are preferably removed by pH adjustment to a pH of not more than 4 and subsequent removal using stripping gas, preferably using inert gas or air. The objective is a residual content, preferably of not more than 50 mg/L, of alkali metal carbonate. Optional removal of carbonates by stripping with stripping gas at a pH in the range of not more than 4 may be carried out either before or after the nanofiltration step, preferably before the nanofiltration step.

A further advantage of using the nanofiltration membrane after the prepurification step with the activated carbon is that all polyvalent ions washed out of the activated carbon with the process water are likewise removed. This makes it possible to dispense with the costly and complex preparation of the activated carbon by acid and alkaline washing.

It is preferable when at least a portion of the highly purified sodium chloride-containing solution from step c1) is introduced into the brine circuit of a membrane electrolysis for producing chlorine, sodium hydroxide solution and optionally hydrogen. It is particularly preferable to produce a mixed brine having a maximum BPA content of 2 mg/L for the membrane electrolysis. The brine should especially preferably have a TOC content of not more than 5 mg/L.

A particularly preferred embodiment of the novel process is characterized in that the electrochemical oxidation d) of at least a portion of the highly purified sodium chloride-containing solution obtained from the nanofiltration c1) to afford chlorine and sodium hydroxide solution is carried out in a membrane electrolysis using an oxygen-consuming electrode as cathode.

In a preferred variant of the novel process it may be necessary before the electrolysis d) to add additional sodium chloride to the highly purified sodium chloride-containing solution from step c1) to increase the sodium chloride concentration or to increase the concentration as described hereinabove.

Preference is therefore also given to an embodiment of the novel process which is characterized in that before the electrolysis d), in particular an electrolysis by means of the membrane electrolysis process, the highly purified sodium chloride-containing solution obtained from step c1) is brought to an NaCl concentration of at least 23% by weight, preferably at least 25% by weight.

A further preferred variant of the novel process is characterized in that the concentrate obtained in the nanofiltration c1), which contains sodium chloride solution and catalyst residues, is sent to a workup g) in which ionic and nonionic catalyst residues are separated from the concentrated sodium chloride solution using a cation exchange resin. It is preferable when the catalyst residues adsorbed on the cation exchange resin are eluted using organic solvents (for example methanol) at a pH of less than 3. Independently thereof the concentrate obtained in the nanofiltration c1) may also be purified by activated carbon treatment in the workup g). Likewise suitable therefor is a coconut shell-based activated carbon as described hereinabove, in particular one which has additionally been subjected to an acid and alkaline washing to remove inorganic constituents from the activated carbon.

In a particularly preferred embodiment of the abovementioned variant of the novel process the purified concentrated sodium chloride solution obtained in step g) is additionally reacted in the electrochemical oxidation d).

In an alternative preferred embodiment of the novel process in cases in which the electrolysis can be operated at a lower NaCl concentration the sodium chloride concentration of the sodium chloride solution entering the electrolysis d) is adjusted to a value of 100 to 320 g/l, preferably 100 to 280 g/l.

The concentration of the sodium hydroxide solution obtained from the electrolysis is then typically 10% to 33% by weight, preferably 12% to 32% by weight. The thus achieved relatively low sodium chloride solution concentration may be advantageous for direct employment in selected chemical processes. However, it is generally the minimum concentration mentioned hereinabove that is sought.

In the electrolysis in step d) it is preferable when employing a membrane electrolysis to employ ion exchange membranes having a water transport per mol of sodium of greater than 4 mol H₂O/mol sodium in the electrolysis d).

It is particularly preferable to employ ion exchange membranes having a water transport per mol of sodium of 5.5 to 6.5 mol H₂O/mol sodium in the electrolysis d).

When employing a membrane electrolysis the electrolysis d) is expediently operated at a current density of 2 to 6 kA/m², wherein the area used as a basis for calculating the current density is the membrane area.

The electrolysis d) is optimally operated at a temperature of 70° C. to 100° C., preferably at 80° C. to 95° C.

Especially when employing a membrane electrolysis the electrolysis d) is operated at an absolute pressure of 1.0 to 1.4 bar, preferably 1.1 to 1.3 bar.

When using a membrane electrolysis the electrolysis d) is expediently operated at a differential pressure between the cathode and anode space of 20 to 150 mbar, preferably 30 to 100 mbar.

The electrolysis d) is preferably operated with an anode which contains as an electroactive coating not only ruthenium oxide but also further noble metal compounds of the 7th and 8th transition group and/or the 4th main group of the periodic table of the elements.

Anodes having a larger surface area than the surface area of the ion exchange membranes may optimally be employed in the electrolysis cells in the electrolysis d).

The reaction b1) of phosgene with at least one bisphenol in the presence of sodium hydroxide solution and optionally amine catalyst to afford a polycarbonate is known in principle.

Polycarbonates in the context of the present invention is to be understood as meaning not only homopolycarbonates but also copolycarbonates and/or polyester carbonates; the polycarbonates may be linear or branched in a known manner Mixtures of polycarbonates may also be used.

The thermoplastic polycarbonates including the thermoplastic aromatic polyester carbonates typically have an average molecular weight M_{w} (determined by measuring the relative viscosity at 25° C. in CH₂Cl₂ and a concentration of 0.5 g per 100 ml of CH₂Cl₂) of 20 000 g/mol to 32 000 g/mol, preferably of 23 000 g/mol to 31 000 g/mol, in particular of 24 000 g/mol to 31 000 g/mol.

A portion of up to 80 mol %, preferably of 20 mol % to 50 mol %, of the carbonate groups in the polycarbonates may be replaced by aromatic dicarboxylic ester groups. Polycarbonates of this type that incorporate not only acid radicals derived from carbonic acid but also acid radicals derived from aromatic dicarboxylic acids in the molecular chain are referred to as aromatic polyester carbonates. In the context of the present invention they are subsumed by the umbrella term “thermoplastic aromatic polycarbonates”.

The polycarbonates are produced in a known manner from diphenols, carbonic acid derivatives, optionally chain terminators and optionally branching agents, and the polyester carbonates are produced by replacing a portion of the carbonic acid derivatives with aromatic dicarboxylic acids or derivatives of the dicarboxylic acids, to a degree according to the extent to which the carbonate structural units in the aromatic polycarbonates are to be replaced by aromatic dicarboxylic ester structural units.

Dihydroxyaryl compounds suitable for producing polycarbonates are those of formula (2)

HO—Z—OH (2),

in which
Z is an aromatic radical which has 6 to 30 carbon atoms and may comprise one or more aromatic rings, may be substituted and may comprise aliphatic or cycloaliphatic radicals or alkylaryls or heteroatoms as bridging elements.
Z in formula (2) preferably represents a radical of formula (3)

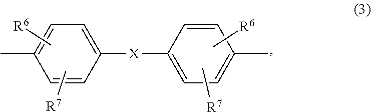

in which
R⁶ and R⁷ independently of one another represent H, C₁- to C₁₈-alkyl-, C₁- to C₁₈-alkoxy, halogen such as Cl or Br or in each case optionally substituted aryl or aralkyl, preferably H or C₁- to C₁₂-alkyl, particularly preferably H or C₁- to C₈-alkyl and very particularly preferably H or methyl, and
X represents a single bond, —SO₂—, —CO—, —O—, —S—, C₁- to C₆-alkylene, C₂- to C₅-alkylidene or C₅- to C₆-cycloalkylidene which may be substituted by C₁- to C₆-alkyl, preferably methyl or ethyl, or else represents C₆- to C₁₂-arylene which may optionally be fused to further aromatic rings containing heteroatoms.

X preferably represents a single bond, C₁- to C₅-alkylene, C₂- to C₅-alkylidene, C₅- to C₆-cycloalkylidene, —O—, —SO—, —CO—, —S—, —SO₂—

or a radical of formula (3a)

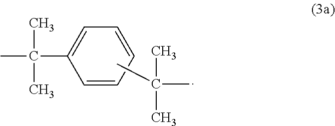

Examples of dihydroxyaryl compounds (diphenols) are: dihydroxybenzenes, dihydroxydiphenyls, bis(hydroxyphenyl)alkanes, bis(hydroxyphenyl)cycloalkanes, bis(hydroxyphenyl)aryls, bis(hydroxyphenyl) ethers, bis(hydroxyphenyl) ketones, bis(hydroxyphenyl) sulfides, bis(hydroxyphenyl) sulfones, bis(hydroxyphenyl) sulfoxides, 1,1′-bis(hydroxyphenyl)diisopropylbenzenes and ring-alkylated and ring-halogenated compounds thereof.

Diphenols particularly suitable for producing the polycarbonates are for example hydroquinone, resorcinol, dihydroxydiphenyl, bis(hydroxyphenyl)alkanes, bis(hydroxyphenyl)cycloalkanes, bis(hydroxyphenyl) sulfides, bis(hydroxyphenyl) ethers, bis(hydroxyphenyl) ketones, bis(hydroxyphenyl) sulfones, bis(hydroxyphenyl) sulfoxides, α,α′-bis(hydroxyphenyl)diisopropylbenzenes and the alkylated, ring-alkylated and ring-halogenated compounds thereof.

Preferred diphenols are 4,4′-dihydroxydiphenyl, 2,2-bis(4-hydroxyphenyl)-1-phenylpropane, 1,1-bis(4-hydroxyphenyl)phenylethane, 2,2-bis(4-hydroxyphenyl)propane, 2,4-bis(4-hydroxyphenyl)-2-methylbutane, 1,3-bis[2-(4-hydroxyphenyl)-2-propyl] benzene (bisphenol M), 2,2-bis(3-methyl-4-hydroxyphenyl)propane, bis(3,5-dimethyl-4-hydroxyphenyl)methane, 2,2-bis(3,5-dimethyl-4-hydroxyphenyl)propane, bis(3,5-dimethyl-4-hydroxyphenyl) sulfone, 2,4-bis(3,5-dimethyl-4-hydroxyphenyl)-2-methylbutane, 1,3-bis[2-(3,5-dimethyl-4-hydroxyphenyl)-2-propyl]benzene and 1,1-bis(4-hydroxyphenyl)-3,3,5-trimethylcyclohexane (bisphenol TMC).

Particularly preferred diphenols are 4,4′-dihydroxydiphenyl, 1,1-bis(4-hydroxyphenyl)phenylethane, 2,2-bis(4-hydroxyphenyl)propane, 2,2-bis(3,5-dimethyl-4-hydroxyphenyl)propane, 1,1-bis(4-hydroxyphenyl)cyclohexane and 1,1-bis(4-hydroxyphenyl)-3,3,5-trimethylcyclohexane (bisphenol TMC).

In the case of the homopolycarbonates only one diphenol is used and in the case of copolycarbonates two or more diphenols are used. The diphenols employed, similarly to all other chemicals and assistants added to the synthesis, may be contaminated with the contaminants from their own synthesis, handling and storage. However, it is desirable to use raw materials of the highest possible purity.

The monofunctional chain terminators required for molecular-weight regulation, for example phenols or alkylphenols, in particular phenol, p-tert-butylphenol, isooctylphenol, cumylphenol, chlorocarbonic esters thereof or acyl chlorides of monocarboxylic acids or mixtures of these chain terminators, are either supplied to the reaction with the bisphenoxide(s) or else are added at any desired juncture in the synthesis provided that phosgene or chlorocarbonic acid end groups are still present in the reaction mixture or, in the case of acyl chlorides and chlorocarbonic esters as chain terminators, as long as sufficient phenolic end groups of the incipient polymer are available. However, it is preferable when the chain terminator(s) is/are added after the phosgenation at a location or at a juncture at which phosgene is no longer present but the catalyst has not yet been added or when they are added before the catalyst or together or in parallel with the catalyst.

Any branching agents or branching agent mixtures to be used are added to the synthesis in the same manner, but typically before the chain terminators. Compounds typically used are trisphenols, quaterphenols or acyl chlorides of tri- or tetracarboxylic acids, or else mixtures of the polyphenols or of the acyl chlorides.

Examples of some of the compounds employable as branching agents and having three or more phenolic hydroxyl groups include phloroglucinol, 4,6-dimethyl-2,4,6-tri(4-hydroxyphenyl)hept-2-ene, 4,6-dimethyl-2,4,6-tri(4-hydroxyphenyl)heptane, 1,3,5-tris(4-hydroxyphenyl)benzene, 1,1,1-tri(4-hydroxyphenyl) ethane, tris(4-hydroxyphenyl)phenylmethane, 2,2-bis[4,4-bis(4-hydroxyphenyl)cyclohexyl]propane, 2,4-bis(4-hydroxyphenylisopropyl)phenol, tetra(4-hydroxyphenyl)methane.

Some of the other trifunctional compounds are 2,4-dihydroxybenzoic acid, trimesic acid, cyanuryl chloride and 3,3-bis(3-methyl-4-hydroxyphenyl)-2-oxo-2,3-dihydroindole.

Preferred branching agents are 3,3-bis(3-methyl-4-hydroxyphenyl)-2-oxo-2,3-dihydroindole and 1, 1,1-tri(4-hydroxyphenyl)ethane.

The amount of the optionally employable branching agents is 0.05 mol % to 2 mol % in turn based on moles of diphenols employed in each case.

The branching agents may either be initially charged with the diphenols and the chain terminators in the aqueous alkaline phase or added dissolved in an organic solvent before the phosgenation. All of these particular abovementioned measures for producing the polycarbonates are in principle familiar to those skilled in the art.

Aromatic dicarboxylic acids suitable for producing the polyester carbonates are, for example, orthophthalic acid, terephthalic acid, isophthalic acid, tert-butylisophthalic acid, 3,3′-diphenyldicarboxylic acid, 4,4′-diphenyldicarboxylic acid, 4,4-benzophenonedicarboxylic acid, 3,4′-benzophenonedicarboxylic acid, 4,4′-diphenyl ether dicarboxylic acid, 4,4′-diphenyl sulfone dicarboxylic acid, 2,2-bis(4-carboxyphenyl)propane, trimethyl-3-phenylindane-4,5′-dicarboxylic acid.

Among the aromatic dicarboxylic acids, particular preference is given to using terephthalic acid and/or isophthalic acid.

Derivatives of dicarboxylic acids are dicarbonyl dihalides and dialkyl dicarboxylates, especially dicarbonyl dichlorides and dimethyl dicarboxylates.

Replacement of the carbonate groups by the aromatic dicarboxylic ester groups is substantially stoichiometric, and also quantitative, and the molar ratio of the reactants is therefore also maintained in the final polyester carbonate. The aromatic dicarboxylic ester groups can be incorporated either randomly or blockwise.

Modes of production for polycarbonates, including polyester carbonates, include the interfacial process which is known per se and the melt transesterification process which is known per se (variants thereof are described for example in WO 2004/063249 A1, WO 2001/05866 A1, WO 2000/105867, U.S. Pat. No. 5,340,905 A).

In the former case the employed acid derivatives are preferably phosgene and optionally dicarbonyl dichlorides and in the latter case preferably diphenyl carbonate and optionally dicarboxylic diesters. Catalysts, solvents, workup, reaction conditions etc. for polycarbonate production or polyester carbonate production are sufficiently well described and known for both cases.

In a preferred novel process the bisphenol employed in step b1) is selected from dihydroxybiphenyls, bis(hydroxyphenyl)alkanes, bis(hydroxyphenyl)cycloalkanes, bis(hydroxyphenyl)sulfides, bis(hydroxyphenyl)ethers and ring-alkylated and ring-halogenated thereof, in particular 2,2-bis(4-hydroxyphenyl)propane (bisphenol A) and 1,1-bis(4-hydroxyphenyl)-3,3,5-trimethylcyclohexane (TMC bisphenol), particularly preferably 2,2-bis(4-hydroxyphenyl)propane (bisphenol A).

The transesterification and reaction in step b2) for forming polycarbonate is known in principle from the documents: Encyclopedia of Polymer Science, Vol. 10 (1969), Chemistry and Physics of Polycarbonates, Polymer Reviews, H. Schnell, Vol. 9, John Wiley and Sons, Inc. (1964).

The invention is hereinbelow more particularly elucidated with reference to the FIGURES by the examples, which do not, however, constitute any limitation of the invention.

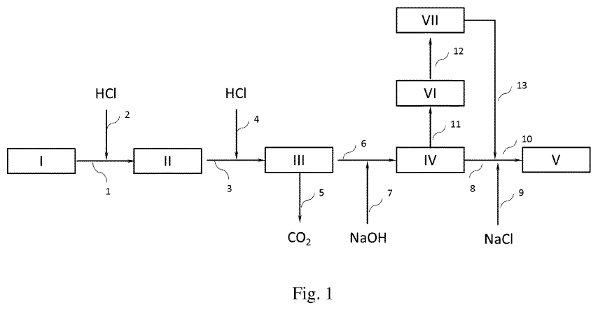

FIG. 1 shows a schematic representation of the process according to the invention for purification of the process water from polycarbonate production by prepurification via activated carbon, removal of carbonate by stripping and nanofiltration.

FIG. 1

The definitions of the reference numerals in the FIGURE are as follows:
I Polycarbonate production (generation of process water)
II Prepurification of the process water using activated carbon
III Removal of carbonate by stripping
IV Nanofiltration
V Brine circuit for chloralkali electrolysis
VI Optional concentrate purification via activated carbon/cation exchanger
VII Optional concentrate purification via ion exchanger
1 Process water from polycarbonate production pH 12-14
2 Hydrochloric acid for adjusting pH to 7-8
3 Process water prepurified via activated carbon
4 Hydrochloric acid for adjusting pH to 2-4
5 Carbon dioxide from the stripping column
6 Prepurified and stripped process water
7 Sodium hydroxide solution for adjusting pH to 6-8
8 Permeate from nanofiltration
9 Solid NaCl
10 Purified and concentrated process water
11 Concentrate from nanofiltration
12 Optionally purified concentrate (organics removal)
13 Optionally purified concentrate (inorganics removal)

### EXAMPLES

General Description of Workup of Process Water

The diphenyl carbonate (DPC) process water I having a TOC content of about 20-100 mg/L, a concentration of ammonium compounds and salts thereof of 0.5-5 mg/L, an NaCl content of 15% to 20% by weight, a carbonate content up to 10 g/L and a pH of 12-14 is initially adjusted with HCl (2) to a pH of less than 8 and sent to the activated carbon purification II. The resulting stream 3 has a concentration of phenols, phenol derivatives and bisphenol A of not more than 2 mg/L. For the optional removal of carbonate by stripping III the process water 3 is adjusted to pH 2-4 with HCl4. The stripped process water 6 having a carbonate concentration of less than 50 mg/L is adjusted to pH 5-8 using sodium hydroxide solution 7 and fed to the nanofiltration IV. In the nanofiltration a concentration factor is established such that at least 50% by weight of the sodium chloride present in the prepurified NaCl solution before the nanofiltration (100% by weight) is retained in the permeate 8. The concentration of ammonium compounds and salts thereof is reduced by at least 90%. The purified permeate 8 may be topped up with solid NaCl 9 until saturation (about 25% by weight) (stream 10) and supplied to the brine circuit of the chloralkali electrolysis V. The concentrate 11 enriched with ammonium compounds and salts thereof and also polyvalent ions may be discarded. Concentrate 11 may optionally be worked up via the additional activated carbon purification/cation exchanger VI and ion exchanger VII and likewise supplied to the brine circuit V.

### Example 1

Four solution batches BV1-BV4 having compositions as reported in table 1 were produced and supplied to the plant as feed stream. The conductivity of the feed was about 110 mS/cm. The test cell was equipped with a GE DK type nanofiltration membrane having an area of about 130 cm². The feed was supplied with a volume flow of 500 ml/min. A constant permeate flow of 500 ml/h was generated. The pressure development on the concentrate side was registered. The concentrate was recycled until a volumetric concentration of about 4 was achieved This means for example that 100 L of feed generates 25 L of concentrate and 75 L of permeate.

The collected permeate and concentrate were then analyzed. The values are reported in table 1.

TABLE 1

| | | | Concentrate | Permeate | | Experimental | | Monochloromethyl- |
|---|---|---|---|---|---|---|---|---|
| | | | conductivity | conductivity | Volumetric | duration | Pressure | ethylpiperidinium |
| | Components | pH | [mS/cm] | [mS/cm] | concentration | [h] | [bar] | chloride retention [%] |
| BV1 | 7% by wt. NaCl | 7 | 120 | 109 | 3.5 | 71 | 27 | — |
| BV2 | 7% by wt. NaCl | 3 | 123 | 106 | 3.67 | 50.5 | 36 | — |
| BV3 | 7% by wt. NaCl + 3.8 ppm | 7 | 121 | 109 | 4.1 | 74 | 29 | 94 |
| | monochloromethylethylpiperidinium | | | | | | | |
| | chloride | | | | | | | |
| BV4 | 7% by wt. NaCl + 3.4 ppm | 3 | 126 | 109 | 3 | 51 | 36 | 94 |
| | monochloromethylethylpiperidinium | | | | | | | |
| | chloride | | | | | | | |

As is apparent from table 1 the GE DK membrane achieved a retention of monochloromethylethylpiperidinium chloride of 94% at both pH 3 and pH 7. Blocking of the membrane was not observed. The increased operating pressure at pH 3 is due to the properties of the membrane.

### Example 2 (Comparison; No Prepurification with Activated Carbon)

Three solution batches BV5-BV7 having compositions as reported in table 2 were produced and a procedure analogous to example 1 was followed. In contrast to the experiment in example 1 the pressure in the test cell underwent a continuous marked increase, thus precluding stable operation of the cell. Experiment BV6 was aborted prematurely since the maximum allowable operating pressure of the membrane of not more than 41 bar had already been achieved after 15 hours. The collected permeate and concentrate were then analyzed. The values are reported in table 2.

TABLE 2

| | | | Concentrate | Permeate | | Experimental | |
|---|---|---|---|---|---|---|---|
| | | | conductivity | conductivity | | duration | Pressure |
| | Components | pH | [mS/cm] | [mS/cm] | Concentration | [h] | [bar] |
| BV5 | 7% NaCl + 5 ppm | 7 | 125 | 102 | 4.3 | 58 | 45 |
| | bisphenol A | | | | | | |
| BV6 | 7% NaCl + 5 ppm | 3 | 132 | 100 | 4.7 | 15 | 55 |
| | bisphenol A | | | | | | |
| BV7 | 7% NaCl + 5 ppm | 9 | 126 | 106 | 4.2 | 44 | 46 |
| | bisphenol A | | | | | | |

As is apparent from the example even small concentrations of bisphenol A result in blocking of the membrane and prepurification of the process water, for example via activated carbon, is therefore necessary.

### Example 3

A doped solution consisting of sodium chloride (130 mS/cm) and ethylpiperidine (EPP) (20 mg/L) was produced and supplied to the plant as feed at a volume flow of 500 ml/min. Three different nanofiltration membranes, GE DK, NF 270 Dow Filmtec and TR 60 Ropur, were tested at pH 3.2 and pH 6.8 (with an area of about 130 cm²). A constant permeate flow of 500 ml/h was generated. The values are reported in table 3.

TABLE 3

| | | | EPP | EPP | |
|---|---|---|---|---|---|
| | | NaCl | retention at | retention at | |
| | | retention | pH 3.2 | pH 6.8 | Pressure |
| | Components | [%] | [%] | [%] | [bar] |
| BV8 | NF 270 Dow | ~0 | 95 | 71 | 5 |
| | Filmtec | | | | |
| BV9 | GE DK | 8 | 96 | 100 | 20 |
| BV10 | TR 60 | ~0 | 48 | 20 | 5 |

As is apparent from table 3 the retention of the membranes is in some cases strongly dependent on pH and membrane properties.

### Example 4

Real process water (reaction and washing water combined) from polycarbonate production having a conductivity of about 100 mS/cm and a TOC value of 40 mg/L was adjusted to pH 7 using hydrochloric acid and supplied to the plant as feed. The concentration of monochloromethylethylpiperidinium chloride was about 5 mg/l. The investigation was carried out with the GE-DK membrane in recirculation mode (permeate and concentrate were returned). The feed pressure was 40 bar. A flow of 29 L/(hm²) was initially established and the retention for NaCl and TOC was measured at 31% and 58% respectively. A volumetric concentration by a factor of four was then performed. This means that 1.5 L of permeate was generated from 2 L of feed solution. The conductivity of the concentrate rose to a value of 131 mS/cm and the flow fell to 15 L/(hm²) at a constant TOC retention of about 56%. This was followed by a twister analysis (qualitative trace analysis) of the feed, permeate and concentrate. The values are reported in table 4. Unfortunately, a quantitative analysis was not possible in the salt solution. Characterization is therefore via the qualitative terms: large amount, moderate amount, small amount based on the relative peak areas of gas chromatograms of the samples. The monochloromethylethylpiperidinium chloride content in the concentrate and permeate was also measured: the concentrate contained 13.8 mg/L, the permeate 0.2 mg/L.

TABLE 4

| Component | Feed | Concentrate | Permeate |
|---|---|---|---|
| Ethylpiperidine | Moderate amount | Large amount | Traces |
| Phenol | Small amount | Small amount | Small amount |
| Bisphenol A | Large amount | Large amount | Large amount |
| Isopropylphenol | Traces | Traces | Traces |
| Butylphenol | Small amount | Small amount | Small amount |

As is apparent from the example the TOC reduction in the permeate was achieved only through retention of ethylpiperidine and monochloromethylethylpiperidinium chloride. Other components passed through the membrane unhindered. The retention of the membrane for NaCl increased from 8% to 31% compared to a doped NaCl solution, thus adversely affecting overall performance. The permeate flow was also well below the values of the doped solution despite a higher pressure being employed. This is attributed to the presence of bisphenol A (see example 2).

### Example 5

Real process water (reaction and washing water combined) from polycarbonate production after prepurification with activated carbon having a conductivity of about 190 mS/cm and a TOC value of 3.1 mg/L was supplied to the plant as feed at pH 7. The concentration of monochloromethylethylpiperidinium chloride in the feed was about 0.7 mg/l. The investigation was carried out with the GE DK membrane. The feed pressure was 35 bar. A concentration by a factor of four was performed. This means that 1.5 L of permeate was generated from 2 L of feed solution. An average flow of 35 L/(hm²) was established. The conductivity of the concentrate rose to 200 mS/cm. The average conductivity of the permeate was 185 mS/cm. The monochloromethylethylpiperidinium chloride content in the permeate was then measured at 0.037 mg/L. This corresponds to a retention of monochloromethylethylpiperidinium chloride of about 95%. Adverse effects such as flow reduction or retention deterioration were not observed.

1.-18. (canceled)

19. An integrated process for workup of process water containing at least catalyst residue and/or organic impurities and sodium chloride from the production of polycarbonate, in particular of diaryl carbonates or of polycarbonate by the solution polymerization process, and subsequent processing of the process water in a downstream sodium chloride electrolysis, comprising at least the steps of:
a) production of phosgene by reaction of chlorine with carbon monoxide,
then either
b1) reaction of the phosgene formed in step a) with at least one bisphenol in the presence of sodium hydroxide solution and optionally catalyst to afford a polycarbonate as the target product and a sodium chloride-containing aqueous solution,
or
b2) transesterification of one or more bisphenols with one or more diaryl carbonates to afford the oligo/polycarbonate and the monophenol,
isolation/separation of the polycarbonate and the monophenol,
reaction of the monophenol in the presence of sodium hydroxide solution and of catalyst with phosgene from step a) and separation of the products aqueous sodium chloride solution, polycarbonate as the target product and diaryl carbonate, wherein the diaryl carbonate is preferably reused in the initial transesterification,
c) separation of the aqueous sodium chloride-containing solution obtained in step b1) or b2) from solvent residues and/or optionally catalyst residues, in particular by stripping the solution with steam, then adjustment of the prepurified solution to a pH of not more than 8 and subsequent purification (II) of the prepurified NaCl solution with adsorbents, in particular with activated carbon,
d) electrochemical oxidation of at least a portion of the sodium chloride-containing solution obtained from step c) to form chlorine, sodium hydroxide solution and optionally hydrogen,
e) wherein at least a portion of the chlorine produced in step d) is recycled into the production of phosgene in step a) and/or
f) optionally at least a portion of the alkali metal hydroxide solution produced in step d) is recycled into the production of polycarbonate in step b1),
wherein following the purification (II) of the sodium chloride-containing solution with adsorbents in step c) the purified NaCl-containing solution is in an additional step c1) subjected to a nanofiltration, wherein the NaCl-containing solution is resolved into a highly purified NaCl solution (8) as permeate and an NaCl-containing concentrate comprising organic and inorganic impurities, the highly purified NaCl solution is sent to the electrochemical oxidation d) and the concentrate is worked up or discarded as desired.

20. The process as claimed in claim 19, wherein the electrochemical oxidation d) of at least a portion of the highly purified sodium chloride-containing solution obtained from the nanofiltration c1) to afford chlorine and sodium hydroxide solution is carried out in a membrane electrolysis using an oxygen-consuming electrode as cathode.

21. The process as claimed in claim 19, wherein the nanofiltration c1) is performed at a temperature of from 10° C. to 45° C.

22. The process as claimed in claim 19, wherein the nanofiltration c1) is performed using a nanofiltration membrane having a separation limit (MWCO) of 150-300 Da.

23. The process as claimed in claim 19, wherein the nanofiltration c1) is performed using a nanofiltration membrane having a separation layer based on piperazinamide.

24. The process as claimed in claim 19, wherein the nanofiltration c1) is performed with a prepurified aqueous NaCl solution having an NaCl concentration in the range of from 4% to 20% by weight.

25. The process as claimed in claim 19, wherein the nanofiltration c1) is performed at a pressure of from 5 to 50 bar.

26. The process as claimed in claim 19, wherein the retention of the nanofiltration membrane for ammonium compounds and salts thereof is in each case independently at least 70%.

27. The process as claimed in claim 19, wherein in the nanofiltration c1) at least 50% of the sodium chloride present in the prepurified NaCl solution before the nanofiltration c1) is retained in the permeate.

28. The process as claimed in claim 19, wherein the membrane used for the nanofiltration c1) has a retention of sodium chloride of not more than 10%.

29. The process as claimed in claim 19, wherein in the purification c) the sodium chloride-containing solution is before the adsorption adjusted to a pH of not more than 8.

30. The process as claimed in claim 19, wherein the permeate flow through the membrane during the nanofiltration (IV) is from 15 to 40 L/(hm²).

31. The process as claimed in claim 19, wherein before the electrolysis d), the highly purified sodium chloride-containing solution obtained from step c1) is brought to an NaCl concentration of at least 23% by weight.

32. The process as claimed in claim 19, wherein bisphenols in the polycarbonate production (I) dihydroxyaryl compounds of formula (2)
HO—Z—OH (2),
in which
Z is an aromatic radical which has 6 to 30 carbon atoms and may comprise one or more aromatic rings, may be substituted and may comprise aliphatic or cycloaliphatic radicals or alkylaryls or heteroatoms as bridging elements, are employed in the reaction b).

33. The process as claimed in claim 19, wherein the bisphenol employed in step b) is selected from the group consisting of dihydroxybiphenyls, bis(hydroxyphenyl)alkanes, bis(hydroxyphenyl)cycloalkanes, bis(hydroxyphenyl)sulfides, bis(hydroxyphenyl)ethers, and ring-alkylated and ring-halogenated thereof.

34. The process as claimed in claim 19, wherein the concentrate obtained in the nanofiltration c1), which contains sodium chloride solution and catalyst residues, is sent to a workup g) in which ionic and nonionic catalyst residues are separated from the concentrated sodium chloride solution using a cation exchange resin and/or the concentrate from c1) is purified using activated carbon and the purified concentrate is optionally sent for reuse for the electrochemical oxidation d).

35. The process as claimed in claim 19, wherein the activated carbon for the adsorption used in step c) and/or in step g) is activated carbon based on pyrolyzed coconut shells.

36. The process as claimed in claim 35, wherein the purified concentrated sodium chloride solution obtained in step g) is additionally reacted in the electrochemical oxidation d).
